(19) United States
(12) Patent Application Publication
(10) Pub. No.: US 2015/0241957 A1
(43) Pub. Date: Aug. 27, 2015

(54) CONTROL APPARATUS, INFORMATION PROCESSING APPARATUS, CONTROL METHOD, INFORMATION PROCESSING METHOD, INFORMATION PROCESSING SYSTEM AND WEARABLE DEVICE

(71) Applicant: Sony Corporation, Tokyo (JP)

(72) Inventors: Hirotaka Ishikawa, Kanagawa (JP); Yasuki Kanema, Tokyo (JP); Satoshi Akagawa, Tokyo (JP)

(73) Assignee: Sony Corporation, Tokyo (JP)

(21) Appl. No.: 14/620,308

(22) Filed: Feb. 12, 2015

(30) Foreign Application Priority Data
Feb. 21, 2014 (JP) 2014-032265

(51) Int. Cl. G06F 3/01; G02B 27/01

(52) U.S. Cl. CPC G06F 3/01; G02B 27/017

(57) ABSTRACT

A control apparatus includes an acquisition unit and an execution unit. The acquisition unit is configured to obtain an action table where processing of operating a wearable device is described, from an external apparatus, the processing being associated with an operation event to be input. The execution unit is configured to execute the processing corresponding to the operation event, based on the action table.

### CROSS REFERENCE TO RELATED APPLICATIONS

This application claims the benefit of Japanese Priority Patent Application JP 2014-032265 filed Feb. 21, 2014, the entire contents of which are incorporated herein by reference.

### BACKGROUND

The present disclosure relates to control apparatuses, information processing apparatuses, information processing systems, control methods and information processing methods, which control wearable devices. The present disclosure also relates to the wearable devices.

A head mount display (HMD) which can be mounted on the head of a user and can show the user an image by a display to be placed in front of the user's eyes has been known.

The head mount display (imaging and displaying apparatus) described in the publication of Japanese Patent Application Laid-open No. 2013-141272 is configured to be capable of communicating to an external apparatus, and to display the image which was sent from the external apparatus (see, for example, paragraph [0023] of the specification of the publication).

### SUMMARY

In cases where a wearable device communicates with an external apparatus, when communication delay arises, there arises a problem that an operation of the wearable device may be delayed.

In view of the circumstances as described above, it is desirable to provide a control apparatus capable of preventing communication delay and allowing a wearable device to work properly; and to provide such a wearable device and the like.

According to an embodiment of the present disclosure, there is provided a control apparatus including an acquisition unit and an execution unit.

The acquisition unit is configured to obtain an action table where processing of operating a wearable device is described, from an external apparatus, the processing being associated with an operation event to be input.

The execution unit is configured to execute the processing corresponding to the operation event, based on the action table.

The control apparatus accordingly executes the processing corresponding to the operation event being input, based on the action table. As a result, in comparison to a case where the control apparatus is to receive an instruction of processing from the external apparatus and execute the instructed processing, it makes it possible to reduce a delay between the control apparatus and the external apparatus. The control apparatus can therefore allow the wearable device to work properly.

The execution unit may be configured to execute display processing of an image by the wearable device, the display processing corresponding to the operation event.

The acquisition unit may be configured to obtain a plurality of action tables including the action table. The execution unit may be configured to execute display processing of images in a plurality of hierarchies corresponding to the respective action tables.

This allows the execution unit to use different action tables depending on the hierarchies.

The acquisition unit may be configured to obtain the plurality of action tables each based on time.

This may allow the control apparatus to obtain an up-to-date action table that corresponds to a new app, at any time, for example.

The acquisition unit may be configured to further obtain an image generated by the external apparatus, and the execution unit may be configured to execute output processing of the image obtained by the acquisition unit to output the image to a display of the wearable device.

This allows the control apparatus to display the image generated by the external apparatus onto the display of the wearable device.

The control apparatus may further include a memory configured to store position information indicating positions of one or more images for displaying the image on the wearable device. The execution unit may be configured to refer to the position information and output the image to the display of the wearable device.

This allows the execution unit to efficiently display the image on the wearable device, by referring to the position information, on the basis of the operation event being input.

The execution unit may be configured to execute processing of switching and displaying a plurality of images as the one or more images.

The one or more images may include an image represented by a plurality of objects. The memory may be configured to store the position information of the one or more images including the image represented by the plurality of objects.

This may allow the execution unit to execute display processing for at least one object among the plurality of objects, so it makes it possible to provide various ways of display processing.

The memory may be configured to store the position information as positions on a plurality of coordinate systems. The execution unit may be configured to allow the image on a second coordinate system out of the plurality of coordinate systems to be positioned within a frame of at least one object among the plurality of objects that represents the image on a first coordinate system out of the plurality of coordinate systems.

According to another embodiment of the present disclosure, there is provided an information processing apparatus including a generation unit and a transmission unit.

The generation unit is configured to create an action table where processing of operating a wearable device is described, the processing being associated with an operation event to be input to a control apparatus of the wearable device.

The transmission unit is configured to send the created action table to the control apparatus.

According to still another embodiment of the present disclosure, there is provided a control method executed by a control apparatus of a wearable device. The method includes obtaining an action table where processing of operating the wearable device is described, from an external apparatus, the processing being associated with an operation event to be input.

The processing corresponding to the operation event is to be executed based on the action table.

According to still another embodiment of the present disclosure, there is provided an information processing method executed by an external apparatus capable of communicating with a control apparatus of a wearable device. The method includes creating an action table where processing of operating the wearable device is described, the processing being associated with an operation event to be input to the control apparatus.

The created action table is to be sent to the control apparatus.

According to still another embodiment of the present disclosure, there is provided an information processing system including a control apparatus of a wearable device; and an external apparatus capable of communicating with the control apparatus.

The external apparatus includes a generation unit and a transmission unit. The generation unit is configured to create an action table where processing of operating a wearable device is described, the processing being associated with an operation event to be input to a control apparatus of the wearable device. The transmission unit is configured to send the created action table to the control apparatus.

The control apparatus includes an acquisition unit and an execution unit. The acquisition unit is configured to obtain the action table from the external apparatus. The execution unit is configured to execute the processing corresponding to the operation event, based on the action table.

According to still another embodiment of the present disclosure, there is provided a wearable device including an operation unit, an acquisition unit and an execution unit.

The operation unit is configured to receive an operation event being input.

The acquisition unit is configured to obtain an action table where the processing associated with the operation event is described, from an external apparatus.

The execution unit is configured to execute the processing corresponding to the operation event, based on the action table.

As described above, according to the present disclosure, it is possible to reduce a delay between the control apparatus and the external apparatus, and allow the wearable device to work properly.

Note that the effect described here is not necessarily limited, but may be any of the effects described in the present disclosure.

These and other objects, features and advantages of the present disclosure will become more apparent in light of the following detailed description of best mode embodiment thereof, as illustrated in the accompanying drawings.

### BRIEF DESCRIPTION OF DRAWINGS

FIG. 1 shows a configuration of a system of a first embodiment, as an information processing system according to an embodiment of the present disclosure;

FIG. 2 is a block diagram showing a configuration of each apparatus of this system;

FIG. 3 shows configuration of software installed in each of a mobile terminal and a control box;

FIG. 4 shows an example of a screen displayed on a display of a wearable device;

FIGS. 5A and 5B show coordinate systems representing a place to position card images and app images;

FIG. 6 shows a sequence of processing of switching images within a card hierarchy or an app hierarchy by swiping to right or left;

FIG. 7 shows an example of an action table for the card hierarchy;

FIG. 8 shows an example of a sequence for comparison with the sequence according to the present disclosure;

FIG. 9 shows a state of switching the screen from the card hierarchy to the app hierarchy by using an animation effect;

FIG. 10 is a sequence diagram of a system regarding the processing of switching of FIG. 9;

FIG. 11 shows a sequence based on an action table containing another operation event which is different from operation events of first and second embodiments;

FIG. 12 shows an example of an action table for the app hierarchy; and

FIG. 13 shows a coordinate system for positioning images in a hierarchy for display and a hierarchy for characters.

### DETAILED DESCRIPTION OF EMBODIMENTS

Hereinafter, an embodiment of the present disclosure will be described with reference to the drawings.

### 1. First Embodiment

### 1) Overall Configuration of Information Processing System Using Wearable Device

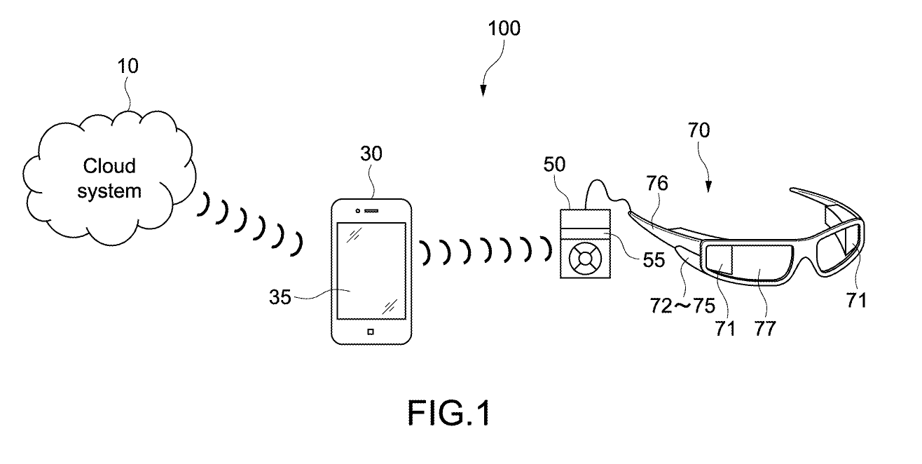

FIG. 1 shows a configuration of a system 100 of a first embodiment, as an information processing system according to an embodiment of the present disclosure.

This system 100 mainly includes a mobile terminal 30, a wearable device (wearable display) 70, and a control box 50 which functions as a control apparatus to control the wearable device 70.

The mobile terminal 30 functions as an information processing apparatus. Typically, the mobile terminal 30 may be a mobile phone such as a smartphone. The mobile terminal 30 may also be a tablet apparatus or other things such as a PC (Personal Computer).

The wearable device 70 is a head-mount type device as shown in the figure; but it is not limited thereto, and it may also be a wrist-band type or neck-band type device, for example.

The mobile terminal 30 is connectable to a cloud system 10. The cloud system 10 includes, for example, a server computer or the like being connected to an electric communication line network such as the Internet.

Typically, the control box 50 is connected to the wearable device 70 via wired connection. A user may operate the wearable device 70 by mounting the wearable device 70 on the head and operating the control box 50 with the fingers.

### 2) Configuration of Each Apparatus

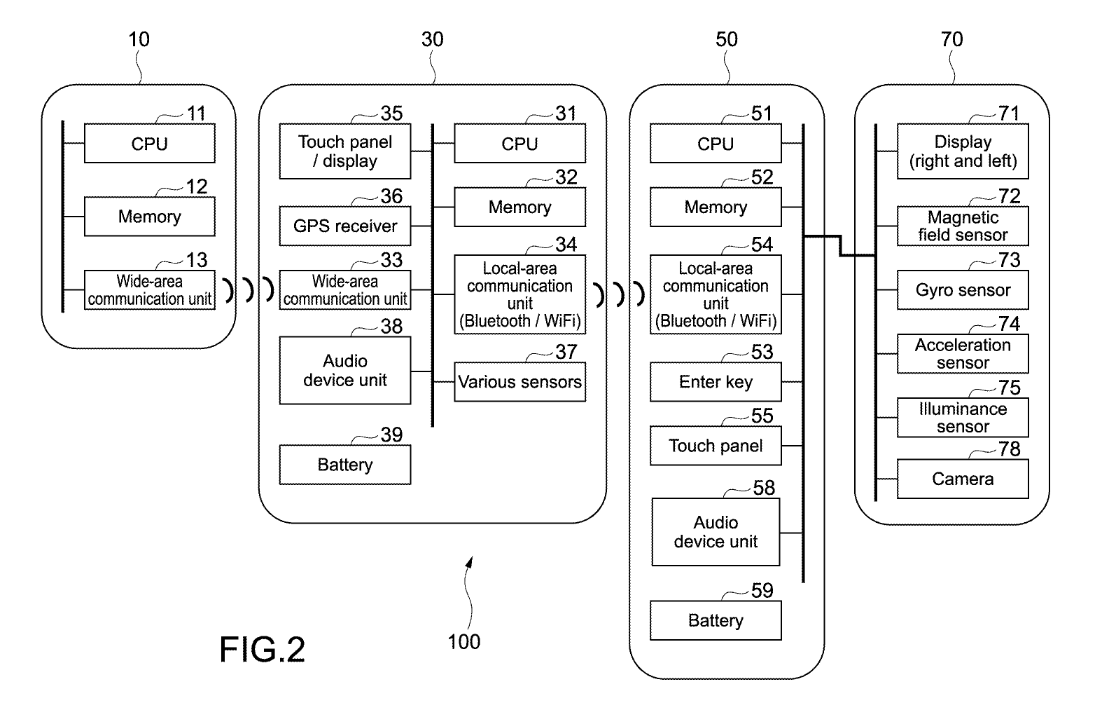

FIG. 2 is a block diagram showing a configuration of each apparatus of the system 100.

### 2-1) Mobile Terminal

The mobile terminal 30 (for example, smartphone) mainly includes a CPU (Central Processing Unit) 31, a memory 32, a touch panel/display 35, a wide-area communication unit 33 and a local-area communication unit 34. The mobile terminal 30 further includes various sensors 37 including a motion sensor, a camera, and the like; a GPS (Global Positioning System) receiver 36; an audio device unit 38; a battery 39; and the like. At least the mobile terminal 30 (or, the mobile terminal 30 and the cloud system 10) functions as an external apparatus with respect to the wearable apparatus 70.

The wide-area communication unit 33 is capable of performing communication using a communication system such as 3G (Third Generation) and LTE (Long Term Evolution), for example. The local-area communication unit 34 is capable of performing communication using a wireless LAN (Local Area Network) communication system such as WiFi; Bluetooth (registered trademark); and/or a short-range wireless communication system such as infrared system; for example. The local-area communication unit 34 functions as a “receiver” and a “transmission unit” between the local-area communication unit 34 and the control box 50.

The mobile terminal 30 may also have an identifying communication device that uses a so-called near-field wireless communication system such as RFID (Radio Frequency IDentification), for example, independently from the local-area communication unit 34.

The audio device unit 38 includes a microphone and a speaker.

### 2-2) Wearable Device

The wearable device 70 has a display 71, various sensors 72 to 75, and a camera 78. The display 71 may include, for example, small-size projectors disposed on right and left sides of a frame 76 of the head-mount type wearable device 70. In this head-mount type wearable device 70, each image light projected from the corresponding projector, the image light being the same or having a parallax between the projectors, would be guided by a light-guiding plate 77. The guided image light would be projected from predetermined regions of the light-guiding plate 77 to the user's eyes.

Examples of the various sensors of the wearable device 70 include a magnetic field sensor 72, a gyro sensor 73, an acceleration sensor 74, an illuminance sensor and the like.

Note that it is also possible that the wearable device 70 has the display 71 only on one side of right and left. The wearable device 70 is not limited to the projector type device; and it may have another type of the display 71 which directly emits the image light to the eyes.

### 2-3) Control Box

The control box 50 includes a CPU 51, a memory 52, a local-area communication unit 54, an enter key 53, a touch panel 55, an audio device unit 58; a battery 59; and the like.

The CPU 51 totally controls each part in the control box 50 and the wearable device 70. The control box 50 may also have a PLD (Programmable Logic Device) such as a FPGA (Field Programmable Gate Array) instead of the CPU 51.

The local-area communication unit 54 is communicable with the local-area communication unit 34 of the mobile terminal 30 by the above-mentioned communication system. The local-area communication unit 54 functions as a “receiver” between the local-area communication unit 54 and the mobile terminal 30.

The enter key 53 includes at least one physical key to be operated by the user, disposed on the control box 50. The enter key 53 includes, for example, a power key, a back key, an ON/OFF key of the display 71, and the like.

The touch panel 55 is an operating device to be operated by the user, disposed on a surface of the control box 50 (see FIG. 1).

The audio device unit 58 includes a microphone and a speaker.

The control box 50 may also have a communication device that uses the above-mentioned near-field wireless communication system such as RFID (Radio Frequency IDentification), for example, independently from the local-area communication unit 54. This may enable the user to perform pairing between the mobile terminal 30 close to the control box 50 in an almost automatic manner, by starting given application software in the mobile terminal 30 and bringing the mobile terminal 30 close to the control box 50.

Further, for example, it is also possible to make the mobile terminal 30 download and install the application software for the pairing, from the cloud, in an almost automatic manner, by the user's action of bringing the mobile terminal 30 close to the control box 50.

As a matter of course, even without such devices for near-field wireless communication, it is also possible that the control box 50 may be capable of performing the pairing with the mobile terminal 30 by using the local-area communication unit 54.

### 2-4) Cloud System

The server computer, for example, which is included in the cloud system 10, has a CPU 11; a memory 12; and a wide-area communication unit 13 configured to be communicable with the mobile terminal 30.

### 3) Software Configuration

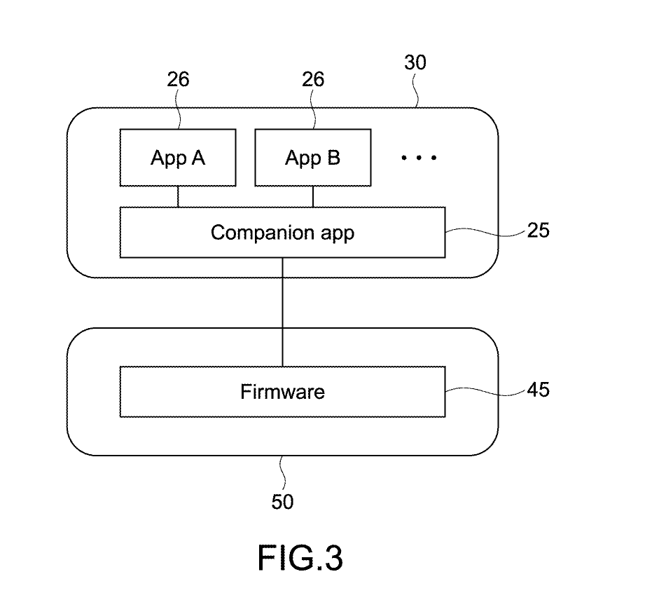

FIG. 3 shows configuration of software installed in each of the mobile terminal 30 and the control box 50.

The mobile terminal 30 stores common application software (hereinafter simply referred to as an “app”) 26 and a companion app 25 in its memory 32. These apps 25 and 26 are configured to work on an OS (Operating System) that has been installed by default in the mobile terminal 30.

Examples of the kinds of the common apps 26 include a SNS (Social Networking Service) app for mini-blogs and community sites; a sound recognition app; a camera app; a media reproduction app; a news app; a weather forecast service app; and the like.

The companion app 25 has a function of converting default data and user data on these apps into data displayable on the display 71 of the wearable device 70. For example, by the mobile terminal 30 downloading the companion app 25 from the cloud system 10, the companion app 25 is installed to this mobile terminal 30.

The control box 50 has firmware 45 in its memory 52. The firmware 45 co-operates with the companion app 25 after the pairing. In the firmware 45, the camera app to operate the camera 78, a setting app for a setting screen which will be described later, and the like, are installed by default.

### 4) Example of Screen Displayed by Wearable Device and Example of Operation of this System

### 4-1) Example of Screen Displayed on Wearable Device

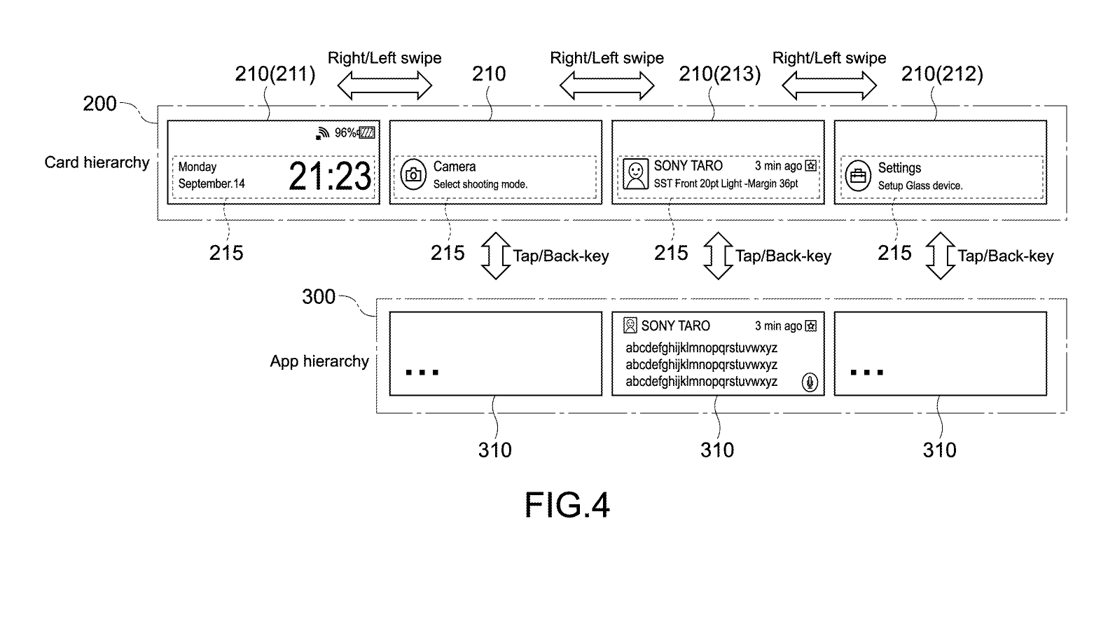

FIG. 4 shows an example of a screen displayed on the display 71 of the wearable device 70. Hereinafter, for convenience of explanation, the companion app 25 will be one that performs the processing of the mobile terminal 30; and the firmware 45 will be one that performs the processing of the control box 50.

### 4-1a) Example of Screen of Card Hierarchy

The hierarchy indicated in the upper row of FIG. 4 is referred to as a “card hierarchy”. The card hierarchy 200 contains a variety of card screens 210 including, for example, a home screen 211, a setting screen 212, and the like, by default. The card hierarchy 200 contains in addition a card screen 210 (213) of the app 26 (see FIG. 3) registered by the user.

The card screens 210 mainly contain images 215 which may be, for example, mostly located at the bottom half region among the entire region of the card screen. A region occupied by one card screen 210 (and an app screen 310 which will be described later) will be a display region (viewport) by the display 71. In the following description, an image in the region occupied by the card screen 210 will be referred to as a “card image”. The card image (except for the card image of the home screen 211) as used in this context would be an image such as an icon, or widget, and this may be a GUI (Graphical User Interface) for accessing to an app. Each card screen 210 is provided with one card image.

The user is able to add the card images, especially the images 215, by registering them. For example, the user may use the mobile terminal 30 and perform an operation of registration to the app 26 installed in the mobile terminal 30, and thus the companion app 25 may generate the card image corresponding to this app 26.

The card image corresponding to the app is, for example, an image containing within the card image a mark and characters that make it recognizable as that app. As will be described later, basically, the companion app 25 stores the card images that it has generated by itself, to the memory 32. The firmware 45 also stores a given number of these card images, to the memory 52.

The firmware 45 in the control box 50 is configured to display these card screens 210 one by one on the display 71. In the same hierarchy, with an input of a swiping operation to right or left by the user via the touch panel 55, the firmware 45 displays each of these card screens 210 on the display 71 in order.

Note that the “Settings” that can be accessed from the setting screen 212 which is one of the card screens 210 also indicates one of the application software; which is a built-in default app in the control box 50.

### 4-1b) Example of Screen of App Hierarchy

The hierarchy indicated in the lower row of FIG. 4 is referred to as an “app hierarchy 300”. Basically, the app hierarchy 300 may be accessible through the card hierarchy 200. The app hierarchy 300 contains app images 310 of app screens on which the respective apps of the card screens 210 are started.

The display 71 displays these app images 310 one by one. The user is able to access the app hierarchy 300 via the card hierarchy 200. When the user intends to access the app hierarchy 300, the user taps the card screen 210 selected from the card hierarchy 200, in the state where the card screen 210 is displayed on the display 71. Then, the firmware 45 displays the app image 310 corresponding to that card screen 210 on the display 71.

When the user intends to return from the app image 310 to the card screen 210, the user presses the back key that has been provided as the enter key 53 of the control box 50 (see FIG. 2).

Further, the user is able to switch the app images 310 within one app, by operating on the touch panel 55 to swipe to right or left, in the state where any one of the app images 310 is displayed in the app hierarchy 300. For example, it is possible to switch a first function of one app, to a second function of that app having the function different from the first function. The number of such functions (number of app images) may vary depending on the app.

In cases where the app is the camera app, for example, the first function may have a screen of still image shooting mode, and the second function may have a screen of video recording mode. Note that the camera app installed in the firmware 45 by default displays on the display 71 an image taken by the camera.

Incidentally, the direction of movement of the images may be the same with the direction of swiping operation by the finger of the user, or may be opposite to this direction. This may be changed by the user's setting.

### 4-1c) Coordinate Systems for Image Positioning

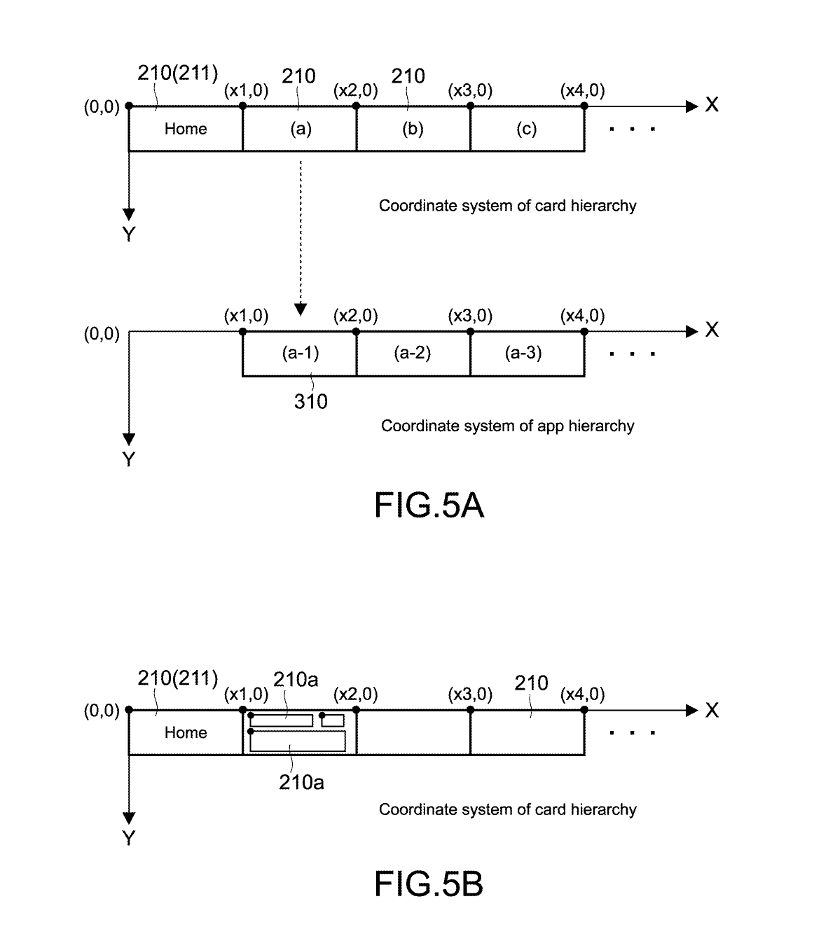

FIGS. 5A and 5B show coordinate systems representing a place to position the card screens 210 and the app images 310. The control box 50 has such coordinate systems stored with respect to each hierarchy, in the memory 52. Further, the control box 50 stores coordinates (position information) of the card screens 210 (card images) and the app images 310 in the memory 52. The card images of the home screen 211 and the setting screen 212, and their position information are stored by default. Further, in cases where there is a plurality of apps in the app hierarchy, the coordinate systems would be stored with respect to each app.

In an example shown in FIG. 5A, the card images are arranged along the X-axis in the coordinate system of the card hierarchy. The coordinate position of each representative point of the corresponding image, for example, an upper left end point (indicated by a black circle) would each be stored in the memory. The same applies to the coordinate system of the app hierarchy. Accordingly, when the operation event of swiping to right or left is input by the user, the firmware 45 specifies the coordinate of the image in accordance with this operation event, and thus extracts from the memory 52 the image corresponding to this coordinate and displays the image onto the display 71. Note that in the example shown in FIG. 5A, the coordinate (x, y) of the home screen 211 is defined as the point of origin (0, 0), for example.

Furthermore, when the operation event by tapping or the back key is input, the firmware 45 may switch back and forth between the card hierarchy and the app hierarchy, at the point corresponding to the coordinate specified based on the coordinate systems, in accordance with this operation event. The firmware 45 also displays the card screen 210 (card image) or the app image 310 corresponding to the specified coordinate.

On the coordinate system of the app hierarchy of the example shown in FIG. 5A, the app images corresponding to a card image (a) indicating an app (a) are arranged along the X-axis (app image (a-1), app image (a-2), app image (a-3), . . . ). Supposing that the coordinate (x, y) of the card image (a) indicating the app (a) is (x1, 0), the position of the app image (a-1) to be first displayed, by a tapping operation from the state where the card image (a) is displayed, may be specified as (x1, 0), for example. In the case of a card image (b), the position of an app image to be first displayed in the app hierarchy may be specified as (x2, 0), for example.

However, alternatively, the positions of the app images may be those in which (0, 0) would be first displayed for each app, in the app hierarchy.

As will be described later, in cases where one card image is made up of a plurality of objects 210a, as shown in FIG. 5B, the coordinate positions of the respective objects 210a would be stored in the memory 52. Although FIG. 5B has shown only the coordinate system of the card hierarchy, the firmware 45 is able to perform display processing of the image including the plurality of objects 210a, on the app hierarchy as well.

By performing display processing of the images based on such coordinate systems, the firmware 45 may efficiently display the images, by referring to the position information of the images.

### 4-2) Processing of Switching Images within Card Hierarchy or App Hierarchy

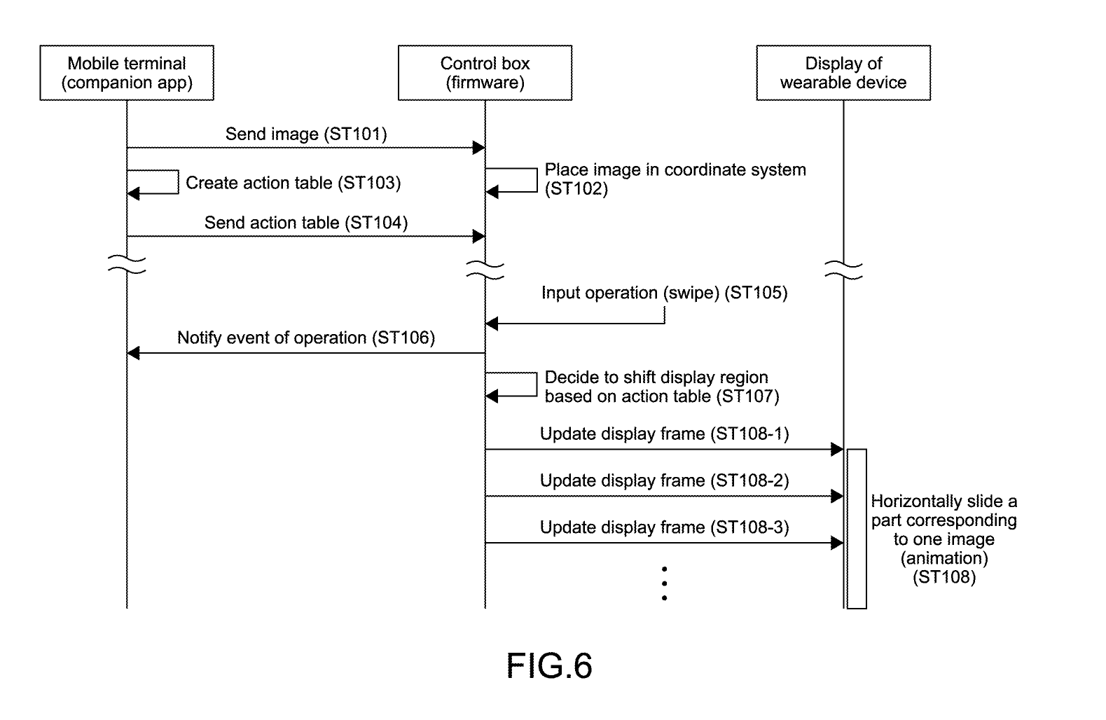

FIG. 6 shows a sequence of processing of switching images within the card hierarchy 200 or the app hierarchy 300 by swiping to right or left.

The companion app 25 sends, for example, an image such as the card image and the app image (step 101). For example, in response to the user's operation on the touch panel 55 to turn the power key of the wearable device 70 ON, or, in response to an input of any operation event by the user, the companion app 25 may send the image. Alternatively, the companion app 25 may send the image automatically without the operation event of the user.

The firmware 45 receives the image and places the received image on the above-mentioned coordinate system (step 102). On the other hand, the companion app 25 creates an action table after sending the image or during sending the image (step 103). In this case, the companion app 25 functions as a “generation unit”.

The action table is a table where processing of operating the wearable device 70 is described, the processing being associated with the operation event to be input by the user. In the action table, typically, there is described display processing of the image within each hierarchy (the card hierarchy 200, the app hierarchy 300, etc.), associated with each operation event to be input by the user via the touch panel 55. The companion app 25 stores action tables in which different contents are described depending on the hierarchies or depending on the apps, in the memory 32.

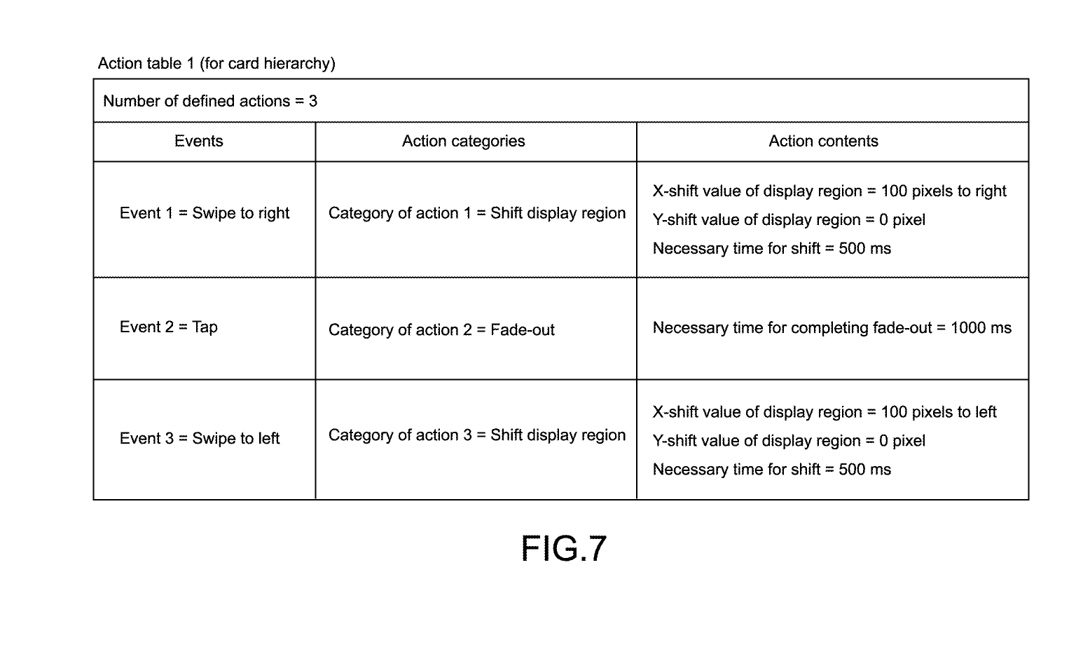

FIG. 7 shows an example of the action table. This action table describes the display processing of the card image or the app image in the card hierarchy 200 or the app hierarchy 300.

The action table according to this example has three definitions of actions (processing). Categories and contents of the actions corresponding to three operation events of “swipe to right”, “tap” and “swipe to left” are described in the action table.

For example, the category of the action corresponding to the “swipe to right”, which is an event (operation event) “1”, is shifting of the display region. The content of this action is shifting the display region for 100 pixels to the right along the X-axis (and the shift in the Y-axis is zero), with the time necessary for the shift being 500 ms.

Incidentally, an operation event “2” of the action table according to this example indicates an action by a tapping operation, in which the card image of the card hierarchy 200 is switched to the app image of the app hierarchy 300 by processing of fade-out animation. This will be described by a second embodiment.

When a new app corresponding to the companion app 25 is installed into the mobile terminal 30, for example, the companion app 25 would then create one or more new action tables corresponding to the installed app.

Referring back to FIG. 6, when the companion app 25 created such an action table, it then sends the resulting action table to the firmware 45 (step 104). In this case, the companion app 25 and the local-area communication unit 34 function as a “transmission unit”. The firmware 45 receives this action table and stores it into the memory 52, for example. In this case, the firmware 45, the local-area communication unit 54, and the like function as an “acquisition unit”.

After that, when any “swipe” to right or left as the operation event by the user is input (step 105), the firmware 45 notifies the companion app 25 of this operation event (step 106).

After this step 106, the companion app 25 executes given processing which is not shown in the figure. As this processing is not directly related to the present disclosure, this will not be described here.

The firmware 45 executes the processing (action content shown in FIG. 7) corresponding to the operation event of the swipe, based on the action table stored in the memory. In this case, the firmware 45 and/or the CPU 51 function as an “execution unit”.

Thus, the firmware 45 decides to shift the display region (step 107), and for example, slides a part corresponding to one image, along the Y-axis (step 108). Note that in step 108, the firmware 45 slides the image and displays it by animation (steps 108-1, 2, 3).

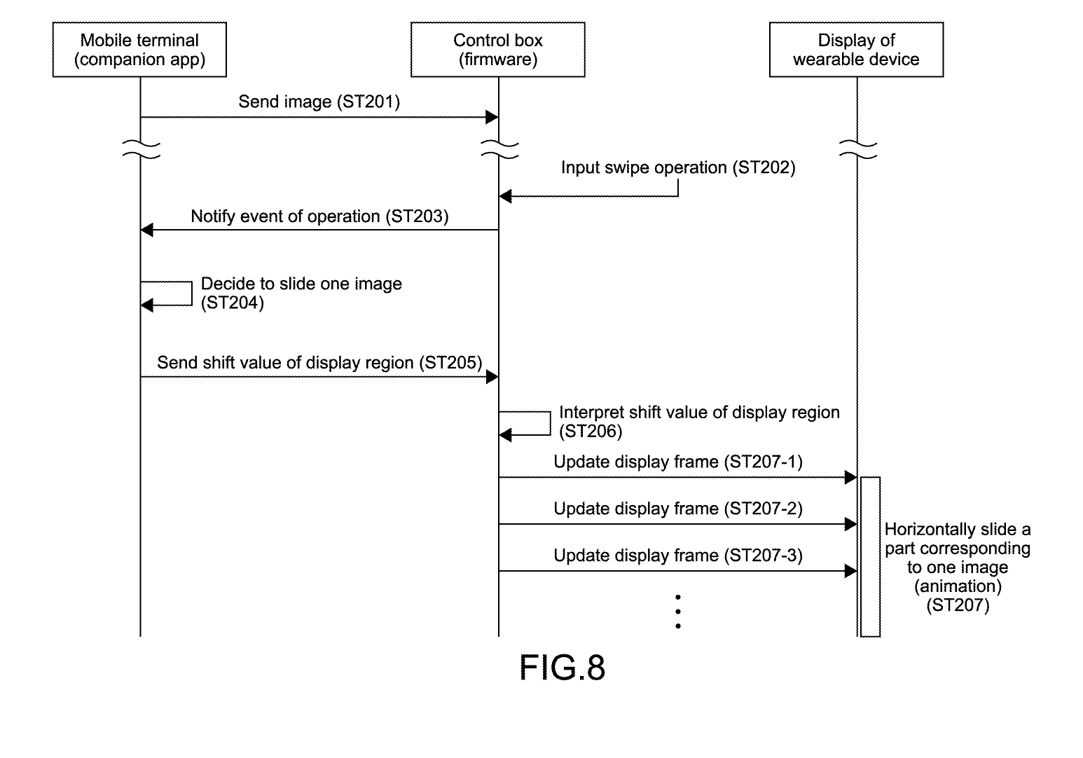

Referring also to an example of a sequence for comparison shown in FIG. 8, advantages of the sequence of FIG. 6 will be described. The sequence shown in FIG. 8 describes a form in which the firmware 45 does not use the action table but executes the display processing by following the instruction from the companion app 25 about the operation event.

Specifically, when the operation event of swiping is notified to the companion app 25 (step 203), the companion app 25 may decide to slide one image (step 204), and may send the shift value of the display region in this case, to the firmware 45 (step 205). The firmware 45, upon receiving it, may interpret the shift value of the display region (step 206), and then slide the image (step 207).

That is, after having the operation event of swiping input in step 202, the processing of steps 203, 204, 205 and 206 should be made by the companion app 25, until sliding the image by step 207. In such a case, there may be a problem that communication delay between the firmware 45 and the companion app 25 may bring discomfort and stress to the user.

In contrast, according to the sequence shown in FIG. 6, the firmware 45 executes the processing corresponding to the operation event being input, based on the action table. That is, after having the operation event input by step 105, the communication between the firmware 45 and the companion app 25 would be made only in step 106. Moreover, step 106 is only a step of notification from the firmware 45 to the companion app 25, so there is almost no delay. Therefore, the firmware 45 is able to prevent communication delay, and display the image properly.

Such a technology makes it possible to display easily viewable images with less stress to the user, even in cases where the hardware of the control box 50 has relatively low specifications. In addition, this makes it possible to reduce power consumption of the control box 50.

### 2. Second Embodiment

This embodiment describes an example where a “tap” operation is input as the operation event and this allows switching images from the card image of the card hierarchy 200 to the app image 310 of the app hierarchy.

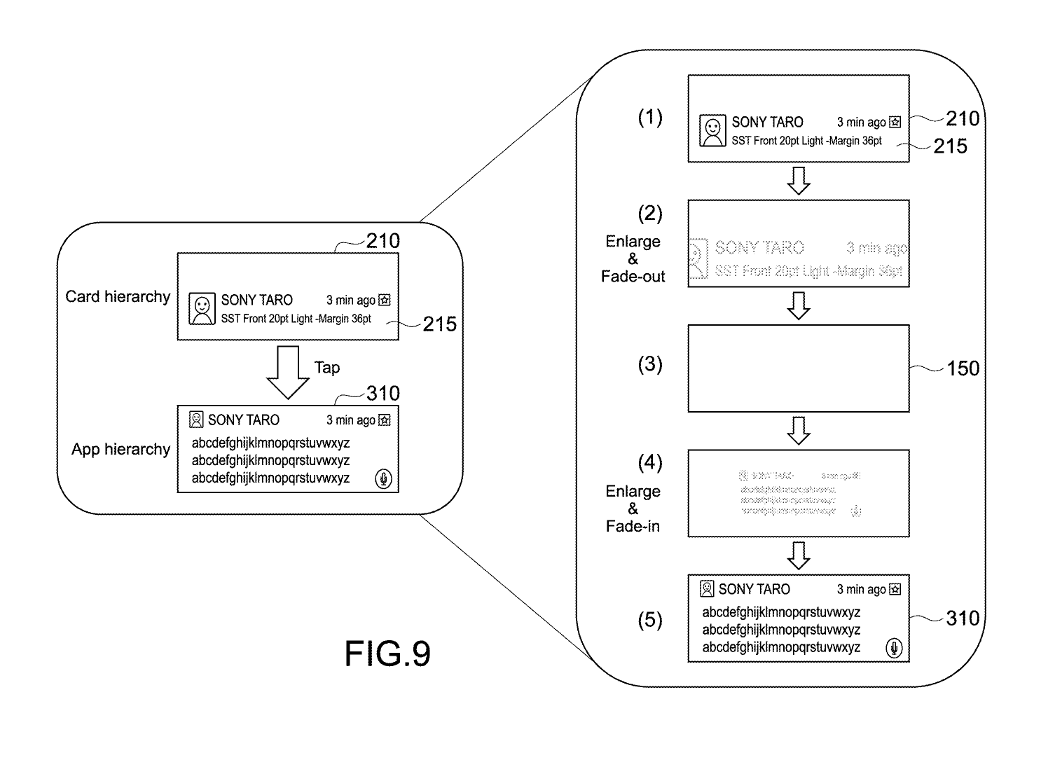

FIG. 9 shows a state of switching the screen by using animation processing, for example.

In the state where any card screen 210 of the card hierarchy 200 is displayed, when the tapping operation as the operation event is input by the user via the touch panel 55, the firmware 45 may display an animation in an order of (1) to (5) as shown in the right part of FIG. 9.

In (1) to (2), the firmware 45 causes the previously-displayed card image (first image) to fade out. This fade-out processing is displaying a plurality of card images at a given frame rate, the card images having their display luminance gradually decreased in order of time. The frame rate may be, for example, 15 fps. This is merely an example, and the frame rate may be smaller or larger than this. In addition, the firmware 45 also executes processing of gradually enlarging the size of the card image, at the same time with the fade-out processing.

In (3), when the firmware 45 finished with the fade-out processing, it clears the displayed card image. An image (third image) of a screen after the image (first image) was cleared in such a way, which is a paternless screen with the remaining background color as that in the display of the first image, will hereinafter be referred to as a “blank image”.

In (4) to (5), the firmware 45 causes the app image (second image) on the app screen 310 corresponding to the app of the above-mentioned card image to fade in. This fade-in processing is displaying a plurality of card images at a given frame rate, the card images having their display luminance gradually increased in order of time. The frame rate may be, for example, 15 fps. This is merely an example, and the frame rate may be smaller or larger than this. In addition, the firmware 45 also executes processing of gradually enlarging the size of the card image (processing of restoring from the small size to the original size), at the same time with the fade-in processing.

Note that, in the above, the card image was expressed as the “first image” and the app image was expressed as the “second image”, but this expression is merely for convenience of explanation. That is, the expression of “first” and “second” merely means an order in which the images are to be displayed when two images are switched.

Although the firmware 45 has inserted a blank image 150, this can be omitted. In other words, the fade-in processing may be performed immediately after the fade-out processing. Even in cases where the processing is performed in this way, there are some cases that the user may recognize that the blank image 150 was inserted, depending on the display luminance of the first and second images.

Furthermore, it is also possible that either one of changing the luminance for each frame and changing the size may be executed in these fade-in and fade-out processing.

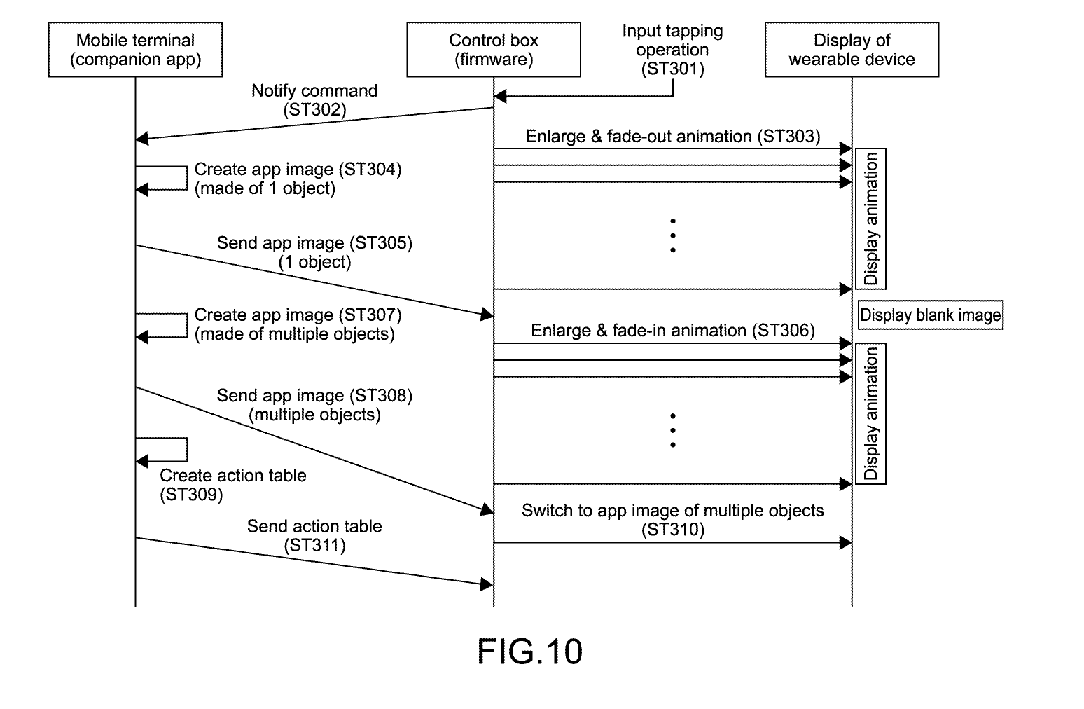

FIG. 10 is a sequence diagram regarding the processing of switching shown in FIG. 9. Note that, as shown in FIG. 10, oblique arrows shown between the companion app 25 and the firmware 45 indicate that there is a possibility of occurrence of communication delay between them.

In the state where the card screen 210 of the card hierarchy 200 is displayed, the user inputs the tapping operation via the touch panel 55 (step 301). Then the firmware 45 of the control box 50 notifies the mobile terminal 30 of this operation event (step 302).

The companion app 25 of the mobile terminal 30 receives the notification of the operation event and generates the app image 310 corresponding to the card image of the card screen 210, based on the operation event (step 304).

This app image is generated by one object. Then, the companion app 25 sends the generated app image 310 made of one object, to the control box 50 (step 305).

On the other hand, the firmware 45, after notifying the operation event, applies the above-described animation processing to the currently displayed card image (step 303). The animation processing to the card image would be performed while the mobile terminal 30 is generating the app image by step 304. This fade-out processing is the processing based on the operation event “2” of the action table according to the example described by FIG. 7.

In the animation processing of step 303, the firmware 45 performs the above-mentioned fade-out processing. In other words, the firmware 45 displays a set of images for animation at the above-mentioned frame rate, the images varying in their sizes and luminance.

At the time when the firmware 45 finished displaying the whole set of images for animation processing in step 303, if the firmware 45 has already received the app image 310 sent by step 305, it applies the animation processing, which is the above-mentioned fade-in processing in this case, to the received app image 310 (step 306).

On the other hand, if the firmware 45 has not received the app image 310 sent by step 305 by the time when it finished displaying the whole set of images for animation processing, the firmware 45 waits for its reception. After the reception, in the same way as the above, the fade-in processing would be applied to the received app image 310 (step 306).

Meanwhile, the companion app 25, after step 305, generates the app image, which is the same image as the app image 310 that has been sent to the control box 50, the image including the plurality of objects 210a (see FIG. 5B) (step 307). Then the companion app 25 sends this app image to the control box 50 (step 308). The firmware 45 would be executing the fade-in processing of the app image (step 306), while the companion app 25 is generating the app image including the plurality of objects by step 307.

Then, at the time when the firmware 45 finished displaying the whole set of images for animation processing in step 306, if the firmware 45 has already received the app image including the plurality of objects sent by step 308, it executes the following processing. That is, the firmware 45 replaces the currently displayed app image 310 made of one object with the received app image including the plurality of objects (step 309).

On the other hand, if the firmware 45 has not received the app image including the plurality of objects sent by step 308 by the time when it finished displaying the whole set of images for animation processing, the firmware 45 waits for its reception. After the reception, in the same way as the above, the firmware 45 would replace the currently displayed app image 310 made of one object with the received app image including the plurality of objects (step 310).

As described above, the control box 50 is configured to apply the animation processing to the currently displayed image, in parallel with the processing by the mobile terminal 30 to generate the image based on the operation event in accordance with the tapping operation, after the notification of this operation event. Thus, even in cases where communication delay may arise, the control box 50 is able to suppress occurrence of drop frame and a jerky state, during the switching of the screen from the card hierarchy 200 to the app hierarchy 300 after the tapping operation. This makes it possible to display easily viewable images with less stress to the user.

The companion app 25, after step 308, creates an action table in the same way as in the first embodiment (step 309) and sends it to the firmware 45 (step 311). Then the firmware 45 receives this new action table, and stores it into the memory.

In such a manner, by obtaining the plurality of objects, the firmware 45 may execute display processing for each of the objects, so it may enable various ways of display processing. The display processing with respect to the object will be described later by a third embodiment.

The sequence shown in FIG. 10 describes switching of the hierarchy by the tapping operation, which would be the switching from the card image to the app image 310 in this case. In other words, as the hierarchy is switched, the companion app creates a new action table (step 309), separately from the action table (for example, FIG. 7) that has been used in the display processing of the card hierarchy. This new action table would be, for example, one which is used for the display processing in the app hierarchy. Accordingly, in this embodiment, the action tables would be switched at the timing when the blank image 150 is displayed (or the timing between the fade-out and fade-in processing), for example.

Although not shown in the figure, the new action table contains a description of processing of switching the images within the app hierarchy, and also contains a description of processing of switching the app image of the app hierarchy to the card image of the card hierarchy by an operation of the back key, for example.

As described above, the firmware 45 is configured to obtain a plurality of action tables each based on time. Therefore, the firmware 45 is able to obtain an up-to-date action table that corresponds to a new app, at any time, for example. The firmware 45 may also discard a previously used action table. This makes it possible to reduce the necessary memory capacity, or to use small-capacity memory.

Note that although this embodiment describes the processing of switching from the card image to the app image, the processing of switching in the reverse case is substantially the same. In addition, according to the fade-in and fade-out processing with the animation in the processing of switching in the reverse case, fade-out and fade-in would be made while the image is enlarged gradually.

### 3. Third Embodiment

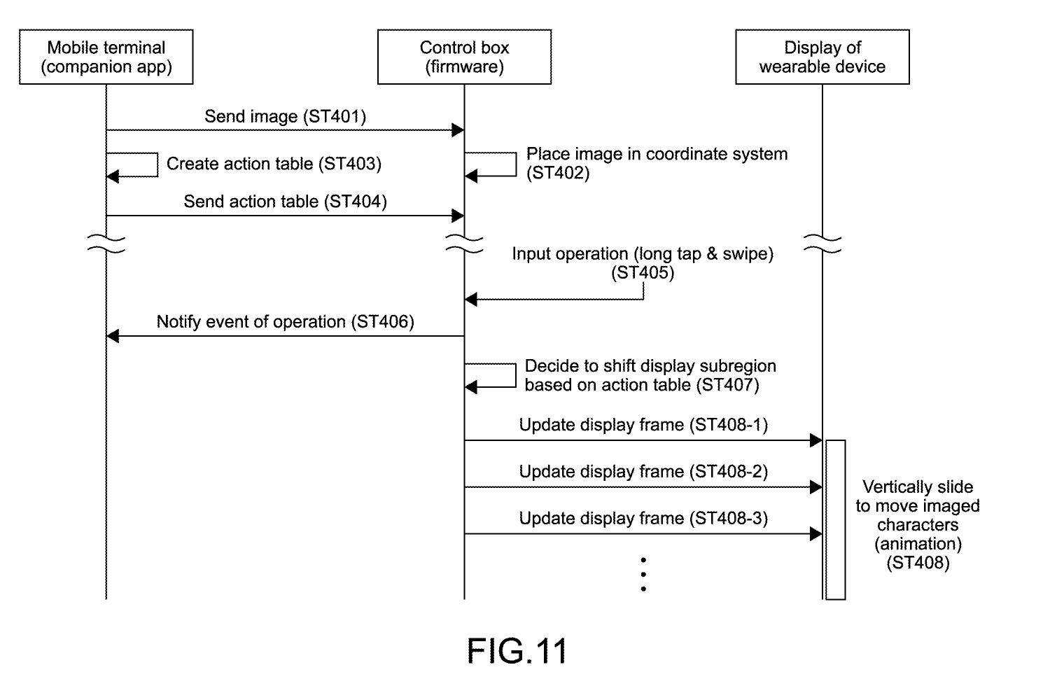

A third embodiment illustrates a sequence based on an action table containing another operation event which is different from the operation events that have been described in the first and second embodiments. FIG. 11 shows such a sequence.

Steps 401 to 404 may be, for example, substantially the same processing steps as the steps 101 to 104 of the sequence shown in FIG. 6.

This case supposes that an operation of “long tap and swipe” is input as the operation event (step 405). The “long tap” means, for example, keeping the finger used for tapping in contact with the touch panel 55 for a predetermined time. The “long tap and swipe” means an operation of keeping the finger in contact with the touch panel 55 for the predetermined time and then swiping with this finger.

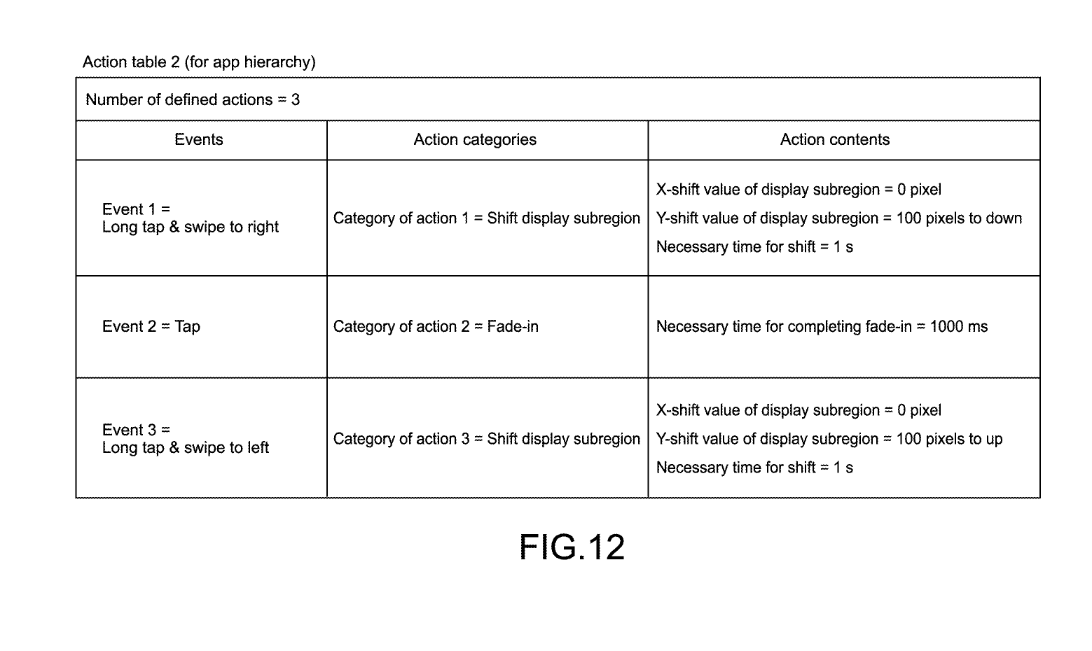

FIG. 12 shows an example of the action table obtained by step 405. In this example, processing corresponding to each of the operation events “1” (long tap and swipe to right) and “3” (long tap and swipe to left) is set as processing of shifting a display subregion to up or down. The “display subregion” is a display region of a part of the entire screen of the display 71. Note that FIG. 11 describes the display processing of the app image in the app hierarchy.

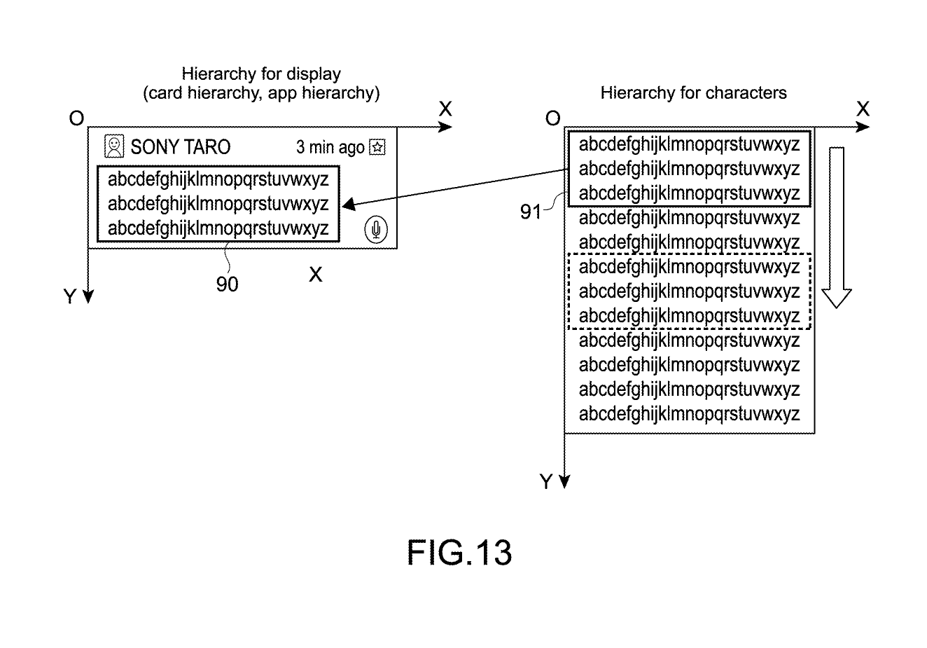

The left part of FIG. 13 shows a position of an image of the display region containing this display subregion 90, in a coordinate system. The left part of FIG. 13 shows a coordinate system (first coordinate system) representing a hierarchy for display (card hierarchy and app hierarchy). The right part of FIG. 13 shows a coordinate system (second coordinate system) representing an image to be displayed in the display subregion 90. In this case, a frame corresponding to the display subregion 90, which is, for example, a frame 91 having the same size as that of the display subregion 90, is set as a coordinate system representing a hierarchy for characters. The firmware 45 stores this plurality of coordinate systems in the memory 52. The firmware 45 is configured to execute processing of cutting out an image in the frame 91 within the coordinate system representing the hierarchy for characters and assigning this image to the display subregion 90 in the coordinate system representing the hierarchy for display.

By displaying the image represented by a plurality of objects within one screen, as described above, the firmware 45 is able to perform display processing of changing such an image within the display subregion 90.

On the basis of the action table (see FIG. 12) that has been obtained by step 403, the firmware 45 decides to vertically shift the display subregion 90 (step 407). Thus, with respect to the frame 91 set in the coordinate system representing the hierarchy for characters, the firmware 45 executes the processing as described in the action table, which is, in this case, shifting vertically (animation processing by automatic scrolling for a predetermined length) (steps 408-1, 2, 3).

According to this embodiment, the firmware 45 is able to execute various kinds of display processing being provided for each app, without generating delay, on the basis of the action table.

### 4. Other Various Embodiments

The present disclosure is not limited to the embodiments described above, and various other embodiments may be made.

The wearable device 70 in each of the embodiments has been described to be connected to the control box 50 via wired connection, or in other words, with an electric cable. However, the wearable device may be a highly-functional one in which the wearable device and the control box are integrated together without the electric cable.

In this case, the control box may be a control apparatus of the wearable device which is embedded inside the wearable device. For example, in this case, an operation unit used for operating the wearable device by the user (for example, the touch panel) may also be mounted integrally to the wearable device.

In the embodiments described above, an apparatus which functions as the image processing apparatus was a portable apparatus such as a mobile phone. However, this may be a non-portable apparatus such as a desktop PC.

In the embodiments described above, the control box 50 and the mobile terminal 30 were configured to be communicable with each other. However, it is also possible that the communication involved in the present disclosure is made by the control box 50 (the wearable apparatus side) and the server computer of the cloud system 10, without being mediated by the mobile terminal 30. In this case, the server computer will be the external apparatus with respect to the wearable device.

In the embodiments described above, although images were illustrated as an example of information to be provided by the wearable device to the user, such information is not limited to images but may be sounds as well.

Although the number of the definitions of actions was three in the action table each shown in the examples of FIGS. 7 and 12, the number thereof may of course be more than three as well.

In the above-described first embodiment, the animation processing was applied to switching of the screen between the card hierarchy 200 and the app hierarchy 300. However, in cases where there is another hierarchy in addition to these hierarchies 200 and 300, the animation processing may also be applied to switching of the screen among those hierarchies.

Out of the characteristic parts of the embodiments described above, at least two characteristic parts can be combined.

The present disclosure can have the following configurations.

(1) A control apparatus including:

an acquisition unit configured to obtain an action table where processing of operating a wearable device is described, from an external apparatus, the processing being associated with an operation event to be input; and

an execution unit configured to execute the processing corresponding to the operation event, based on the action table.

(2) The control apparatus according to (1), in which

the execution unit is configured to execute display processing of an image by the wearable device, the display processing corresponding to the operation event.

(3) The control apparatus according to (2), in which

the acquisition unit is configured to obtain a plurality of action tables including the action table, and

the execution unit is configured to execute display processing of images in a plurality of hierarchies corresponding to the respective action tables.

(4) The control apparatus according to (3), in which

the acquisition unit is configured to obtain the plurality of action tables each based on time.

(5) The control apparatus according to any one of (2) to (4), in which

the acquisition unit is configured to further obtain an image generated by the external apparatus, and

the execution unit is configured to execute output processing of the image obtained by the acquisition unit to output the image to a display of the wearable device.

(6) The control apparatus according to (2), further including

a memory configured to store position information indicating positions of one or more images for displaying the image on the wearable device;

the execution unit being configured to refer to the position information and output the image to the display of the wearable device.

(7) The control apparatus according to (6), in which

the execution unit is configured to execute processing of switching and displaying a plurality of images as the one or more images.

(8) The control apparatus according to (6) or (7), in which

the one or more images includes an image represented by a plurality of objects, and

the memory is configured to store the position information of the one or more images including the image represented by the plurality of objects.

(9) The control apparatus according to (7), in which

the memory is configured to store the position information as positions on a plurality of coordinate systems, and

the execution unit is configured to allow the image on a second coordinate system out of the plurality of coordinate systems to be positioned within a frame of at least one object among the plurality of objects that represents the image on a first coordinate system out of the plurality of coordinate systems.

(10) The control apparatus according to any one of (1) to (9), in which

the external apparatus is
a mobile terminal, or
a server computer in a cloud system.
   (11) An information processing apparatus including:

a generation unit configured to create an action table where processing of operating a wearable device is described, the processing being associated with an operation event to be input to a control apparatus of the wearable device; and

a transmission unit configured to send the created action table to the control apparatus.

(12) A control method executed by a control apparatus of a wearable device, the method including:

obtaining an action table where processing of operating the wearable device is described, from an external apparatus, the processing being associated with an operation event to be input; and

executing the processing corresponding to the operation event, based on the action table.

(13) An information processing method executed by an external apparatus capable of communicating with a control apparatus of a wearable device, the method including:

creating an action table where processing of operating the wearable device is described, the processing being associated with an operation event to be input to the control apparatus; and

sending the created action table to the control apparatus.

(14) An information processing system including:

a control apparatus of a wearable device; and

an external apparatus capable of communicating with the control apparatus,
the external apparatus including
   a generation unit configured to create an action table where processing of operating a wearable device is described, the processing being associated with an operation event to be input to a control apparatus of the wearable device, and
   a transmission unit configured to send the created action table to the control apparatus;
the control apparatus including
   an acquisition unit configured to obtain the action table from the external apparatus, and
   an execution unit configured to execute the processing corresponding to the operation event, based on the action table.
      (15) A wearable device including:

an operation unit configured to receive an operation event being input;

an acquisition unit configured to obtain an action table where the processing associated with the operation event is described, from an external apparatus; and

an execution unit configured to execute the processing corresponding to the operation event, based on the action table.

It should be understood by those skilled in the art that various modifications, combinations, sub-combinations and alterations may occur depending on design requirements and other factors insofar as they are within the scope of the appended claims or the equivalents thereof.

What is claimed is:

1. A control apparatus, comprising:
an acquisition unit configured to obtain an action table where processing of operating a wearable device is described, from an external apparatus, the processing being associated with an operation event to be input; and
an execution unit configured to execute the processing corresponding to the operation event, based on the action table.

2. The control apparatus according to claim 1, wherein
the execution unit is configured to execute display processing of an image by the wearable device, the display processing corresponding to the operation event.

3. The control apparatus according to claim 2, wherein
the acquisition unit is configured to obtain a plurality of action tables including the action table, and
the execution unit is configured to execute display processing of images in a plurality of hierarchies corresponding to the respective action tables.

4. The control apparatus according to claim 3, wherein
the acquisition unit is configured to obtain the plurality of action tables each based on time.

5. The control apparatus according to claim 2, wherein
the acquisition unit is configured to further obtain an image generated by the external apparatus, and
the execution unit is configured to execute output processing of the image obtained by the acquisition unit to output the image to a display of the wearable device.

6. The control apparatus according to claim 2, further comprising
a memory configured to store position information indicating positions of one or more images for displaying the image on the wearable device;
the execution unit being configured to refer to the position information and output the image to the display of the wearable device.

7. The control apparatus according to claim 6, wherein
the execution unit is configured to execute processing of switching and displaying a plurality of images as the one or more images.

8. The control apparatus according to claim 6, wherein
the one or more images includes an image represented by a plurality of objects, and
the memory is configured to store the position information of the one or more images including the image represented by the plurality of objects.

9. The control apparatus according to claim 7, wherein
the memory is configured to store the position information as positions on a plurality of coordinate systems, and
the execution unit is configured to allow the image on a second coordinate system out of the plurality of coordinate systems to be positioned within a frame of at least one object among the plurality of objects that represents the image on a first coordinate system out of the plurality of coordinate systems.

10. The control apparatus according to claim 1, wherein
the external apparatus is
a mobile terminal, or
a server computer in a cloud system.

11. An information processing apparatus comprising:
a generation unit configured to create an action table where processing of operating a wearable device is described, the processing being associated with an operation event to be input to a control apparatus of the wearable device; and
a transmission unit configured to send the created action table to the control apparatus.

12. A control method executed by a control apparatus of a wearable device, the method comprising:
obtaining an action table where processing of operating the wearable device is described, from an external apparatus, the processing being associated with an operation event to be input; and
executing the processing corresponding to the operation event, based on the action table.

13. An information processing method executed by an external apparatus capable of communicating with a control apparatus of a wearable device, the method comprising:
creating an action table where processing of operating the wearable device is described, the processing being associated with an operation event to be input to the control apparatus; and
sending the created action table to the control apparatus.

14. An information processing system comprising:
a control apparatus of a wearable device; and
an external apparatus capable of communicating with the control apparatus,
the external apparatus including
a generation unit configured to create an action table where processing of operating a wearable device is described, the processing being associated with an operation event to be input to a control apparatus of the wearable device, and
a transmission unit configured to send the created action table to the control apparatus;
the control apparatus including
an acquisition unit configured to obtain the action table from the external apparatus, and
an execution unit configured to execute the processing corresponding to the operation event, based on the action table.

15. A wearable device comprising:
an operation unit configured to receive an operation event being input;
an acquisition unit configured to obtain an action table where the processing associated with the operation event is described, from an external apparatus; and
an execution unit configured to execute the processing corresponding to the operation event, based on the action table.
